(19) United States
(12) Patent Application Publication
(10) Pub. No.: US 2005/0220163 A1
(43) Pub. Date: Oct. 6, 2005

(54) External resonator and semiconductor laser module using the same

(75) Inventors: Michitaka Okuta, Tokyo (JP); Yoshiyuki Shigeoka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: KYOCERA CORPORATION, Kyoto (JP)

(21) Appl. No.: 11/091,303

(22) Filed: Mar. 28, 2005

(30) Foreign Application Priority Data
Mar. 26, 2004 (JP) JP2004-093888

(51) Int. Cl. H01S 3/08

(52) U.S. Cl. 372/92

(57) ABSTRACT

An external resonator is provided with a fiber having a fiber Bragg grating for reflecting light of a specific wavelength and a ferrule which holds the above described fiber inside thereof. At least some phase gratings from among the respective phase gratings that form fiber Bragg grating are inclined relative to the optical axis of the fiber.

### BACKGROUND

1. Field of the Invention

The present invention relates to an optical fiber provided with a fiber Bragg grating, an external resonator using the optical fiber, and a semiconductor laser module using the external resonator.

2. Description of the Related Art

It is desirable for a semiconductor laser to provide a stable laser light in terms of its wavelength, as well as its output power, in any environmental conditions. In a Fabry-Perot semiconductor laser, light repeatedly reflects between end surfaces of a laser chip, of which length is not greater than 500 μm, and oscillates in multi-mode. Accordingly, spectrum properties of a laser light tend to spread. Also, if the materials of the semiconductor laser element thermally expand, the refractive index in an active region changes, and thereby, the length of a resonator between end surfaces changes. This results in a change of the oscillation wavelength of laser light. In order to prevent this problem, a fiber Bragg grating (hereinafter referred to as FBG) having a reflectance of several percent may be installed on an outside of semiconductor lasers as an external resonator. If FBGs are installed, a primary oscillation is caused by a reflection of FBG and thereby, an oscillation wavelength spectrum becomes approximately the same as the reflection wavelength properties of the FBG.

FBG is formed by causing a periodical change of refractive index within a fiber core. FBG is conventionally manufactured by means of irradiation of ultraviolet rays through a phase mask. FIG. 11A shows a process for forming FBG.

FIG. 17 shows a semiconductor laser module 13 where a fiber Bragg grating 26 is mounted as an external resonator. FIG. 17 shows the configuration where the FBG 1 is mounted inside a ferrule 3. Alternatively, the FBG 1 may be installed within an output fiber 2′ which is out of the ferrule 3. The FBG 1 partially reflects light 19 that has been emitted from a semiconductor laser element 10. Accordingly, a resonance occurs between the FBG 1 and the semiconductor laser element 10 in the reflection wavelength of the FBG 1, which functions as an external resonator.

An optical isolator 6, which is a kind of optical elements, has a function of preventing light from returning into semiconductor laser element 10. Optical isolators are provided with two polarizers on both sides of a Faraday rotator. Optical isolator have several types including: a type where respective elements are layered; and integrated and a type where the respective elements are in sphere lens form (see Japanese Patent No. 2916960).

### SUMMARY

Respective phase gratings 33 that form an FBG are conventionally formed to be perpendicular to the optical axis 36 of the fiber, and reflection occurs between the respective phase gratings 33, due to a difference in the refractive index, on the basis of Fresnel's formula. In one aspect, a multiple reflection occurs between the phase gratings 33 on the two ends, and a phenomenon which is referred to as Fabry-Perot resonation occurs. In this case, side lobes having a number of peaks overlap the spectrum of the reflected diffraction light, resulting in spectrum properties having a flared foot, such as light from an LED.

In the process for forming FBG, a design technique referred to as apodization can be used, in which the strength distribution of irradiated UV light is controlled to be in the Gaussian state, thus making a distribution of the refractive index. This technique allows the refractive index of the phase gratings 33 that form the FBG 1 to be provided with a distribution as shown in FIG. 11A, and thus, the Fabry-Perot resonation can be suppressed.

By providing a refractive index modulation of the Gaussian state in the longitudinal direction of the phase gratings 33 that form the FBG 1, the Fabry-Perot resonation can be suppressed to some extent. However, side lobes having a number of peaks as shown in FIG. 11B in the spectrum properties cannot be completely removed.

In addition, in the case where the length of a ferrule 3 that holds the optical fiber 2 is short, the light that has entered into a cladding 34 propagates without change and a portion thereof returns, which may interferes with light propagating within the fiber core 27 to cause periodic intensity fluctuation of outputting light.

In addition, if a temperature is not controlled at the portion of FBG 1, the optical fiber 2 in which FBG 1 is installed may expand or contract as the temperature changes, resulting in a fluctuation of the period of gratings 33 in the FBG 1. Accordingly, the spectrum properties of the reflection wavelength may change and, thereby, the oscillation wavelength of the semiconductor laser module 13 fluctuates, making the properties of module unstable.

Further, in the conventional semiconductor laser module 13, the laser oscillation may become unstable if unnecessary light 22, in particular a light having a close wavelength to the oscillation wavelength of the laser, enters the semiconductor laser element 10 and interferes with oscillating light. In order to prevent this, an optical isolator 6 is generally installed on the emission side of the semiconductor laser element 10 so as to block the returning unnecessary light 22 on the emission side. In the case where FBGs 1 are utilized as external resonators 26, however, when the optical isolator 6 for blocking unnecessary light 22 is installed between the semiconductor laser element 10 and the FBG 1, the FBG 1 cannot function as an external resonator 26. Therefore, it is necessary to separately connect an inline type optical isolator to an output fiber 2′ of a semiconductor laser module 13.

FIG. 16 shows a structure of an inline type optical isolator. An inline type optical module 18 shown in FIG. 16 transmits light 19, which has been emitted from the semiconductor laser module 13, but removes unnecessary light 22 such as reflected returning light. However, an inline type optical isolator 6, which is expensive, is separately prepared before being mounted, and therefore, the number of parts increases, requiring a large mounting space.

In order to solve the above described problem, the present invention provides an external resonator comprising an optical fiber having a core and a cladding, said core being formed with a fiber Bragg grating that reflects light of a specific wavelength; and a ferrule that holds said optical fiber, wherein at least part of phase gratings in said fiber Bragg grating are inclined against an orthogonal plane of an optical axis of said optical fiber. As respective phase gratings within a FBG are inclined against an orthogonal plane of the optical axis of the optical fiber, an interference between reflected light and incident light are suppressed, and the Fabry-Perot resonance on both ends can be decreased as well. Therefore, side lobes and branched peaks are suppressed and, thereby, steep spectrum properties can be obtained.

It is preferable for an angle formed between the phase gratings and an orthogonal plane of the optical axis of the fiber (inclination angle β) to satisfy the following expressions:
0°<β≦θ_{c}/2
θc=sin⁻¹(2Δ)^{1/2}
Δ=(n₁²−n₂²)/(2×n¹²)
where n₁ is a refractive index of a core of the fiber, n₂ is a refractive index of a cladding of the fiber and θ_{c} is a critical angle where propagating light is totally reflected. When these conditions are met, the spectrum properties are further improved. Here, a critical angle θ_{c} means an angle formed between a light-propagating direction and a core-cladding interface.

Furthermore, it is preferable to provide a metal thin film around the external periphery of the cladding of the fiber. In the case where a metal thin film is deposited around the external periphery of the cladding, light that has entered the cladding can be prevented from propagating in the cladding mode and coupling to light propagating through the core. Accordingly, the output of the reflected diffraction light can stabilize.

In addition, it is preferable to shape an end face of the optical fiber mounted within the ferrule. In the case where one end face of the optical fiber is shaped, the external resonator can be mounted on a Peltier element for adjusting the temperature within the semiconductor laser module. If the external resonator is mounted on the Peltier element, a period of the periodical refractive index change in FBG become less sensitive to a change in the environmental temperature and a stable light in terms of wavelength and intensity can be outputted.

Furthermore, in the case where an optical element such as an optical isolator is attached to an end surface of the ferrule, unnecessary light in the vicinity of the oscillation wavelength of the semiconductor laser is removed and, thus, the semiconductor laser can stably oscillate. The attached optical element preferably has an optical isolator function and an optical filtering function so as to eliminate the need of separately mounting optical modules having such functions and to reduce the number of parts and a mounting space. The optical element may have only the optical filtering function.

It is preferable that a coupling lens is coupled to an end surface of the ferrule. The optical element may have a form that has a lens function.

The optical fiber may be a core expanded fiber. Further, the optical fiber may be a polarization maintaining fiber, still further a rare earth element may be added to the composition of the fiber.

The external resonator can be mounted between a semiconductor laser element and an end face of a output fiber in a semiconductor laser module. Thus, a semiconductor laser module having excellent spectrum properties can be provided. An external resonator of the present invention can be applied to various types of semiconductor laser modules, such as a high power light source, a wavelength-variable light source, and inline type light modules.

### BRIEF DESCRIPTION OF THE DRAWINGS

FIG. 1 is a cross section showing an external resonator according to the first embodiment of the present invention;

FIG. 2A is an exploded view of the portion A of FIG. 1;

FIG. 2B is an exploded view of the portion B of FIG. 2A showing tracks of light beams of incident light and reflected diffraction light within the FBG;

FIG. 3 is a cross section of an external resonator where one end of the fiber is shaped;

FIGS. 3A to 3C are cross sections showing examples where an end face of an optical fiber of FIG. 3 is shaped, where the views of FIG. 3A show an example where the end is in wedge form, FIG. 3B shows an example where the end is in spherical and FIG. 3C shows an example where the end is in conical;

FIG. 4A is a cross section showing an external resonator according to another embodiment of the present invention;

FIG. 4B is a cross section showing an affixed optical element according to another embodiment;

FIG. 5 is a cross section showing an external resonator according to another embodiment, where one side of an external resonator, such as that of FIG. 4, is provided with a spherical lens;

FIG. 6 is a cross section showing another embodiment where an optical element provided on one side is an optical isolator;

FIG. 7 shows an embodiment where an external resonator, such as that of FIG. 6, is mounted on a Peltier element of a semiconductor laser module;

FIG. 8 shows another embodiment where a coupling lens is attached to one side of an external resonator and integrally mounted in a semiconductor laser module;

FIG. 9 is a cross section showing an embodiment where integration is achieved by providing a lens function to an optical element attached to one side of an external resonator;

FIG. 10 is a top plan view of an embodiment where an external resonator is mounted on a surface mounting type optical module;

FIG. 11A is a cross section showing a conventional manufacturing method for FBG, which is to be utilized in an external resonator;

FIG. 11B is a graph showing a reflection spectrum of an external resonator manufactured by a process shown in FIG. 11A;

FIG. 12A is a cross section showing a manufacturing method for FBG, which is to be utilized in an external resonator;

FIG. 12B is a graph showing a reflection spectrum of an external resonator manufactured by a process shown in FIG. 12A;

FIG. 13 is a schematic diagram showing a measuring system for an oscillation spectrum of a semiconductor laser module;

FIG. 14 is a graph showing oscillation spectrum properties of a semiconductor laser module with an external resonator according to the present invention;

FIG. 15A is a graph showing a relationship between a center wavelength and a temperature where an external resonator is utilized for a semiconductor laser module;

FIG. 15B is a graph showing a relationship between an output power and time where an external resonator is utilized for a semiconductor laser module;

FIG. 16 is a diagram showing a prior art configuration of an inline type optical module; and

FIG. 17 is a diagram showing a prior art semiconductor laser module with an FBG.

### DESCRIPTION OF THE PREFERRED EMBODIMENTS

The application is based on applications Nos. 2003-88998 and 2004-93888 filed in Japan, the content of which are incorporated herein by reference and from which priority is claimed.

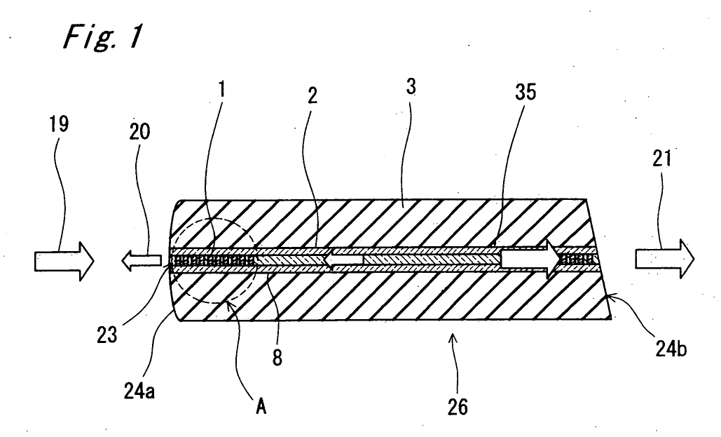

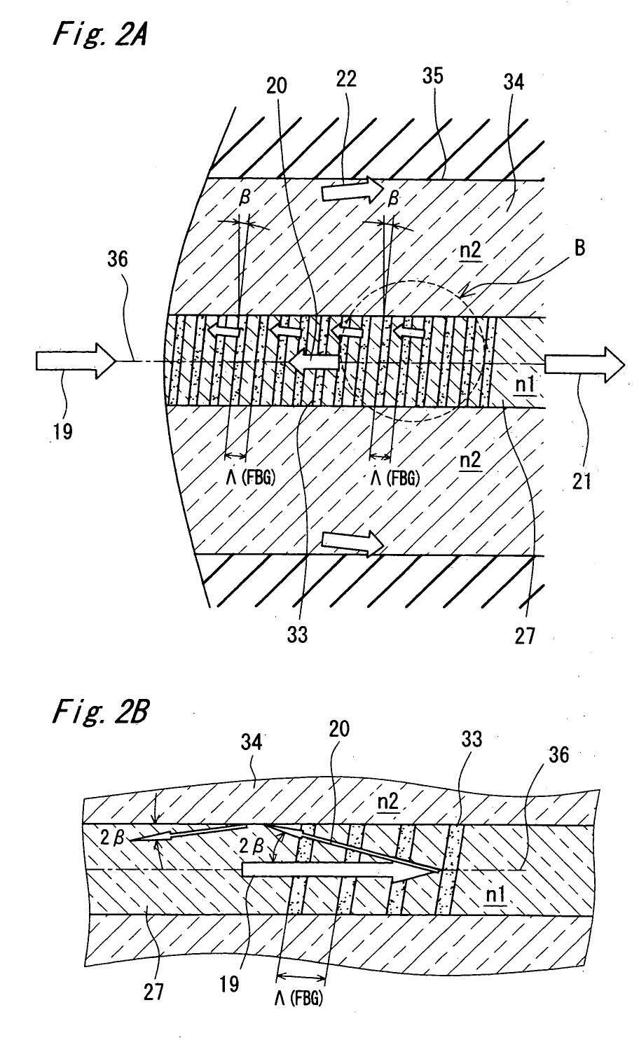

Referring to FIG. 1, an optical fiber 2 that is provided with an FBG 1 for partially reflecting light of a specific wavelength is mounted within a ferrule 3. FBG 1 is formed within an optical fiber that includes a core 27 and a cladding 34, as shown in FIG. 2. FBG 1 maybe provided by forming a plurality of phase gratings 33 in the core 27. The following relationship is satisfied when a period of phase gratings in an FBG 1 is denoted as Λ (FBG) and a period of grating patterns in a phase mask 17 is denoted as Λ (MASK):
Λ(MASK)=2×Λ(FBG)

In order to form FBG 1, a portion of the fiber core 27 in the optical fiber 2 is irradiated with ultraviolet rays so that plural portions having a high refractive index is formed, where the refractive index is increased by approximately 0.001 to 0.01. In order to facilitate changes in refractive index within a fiber core, a high concentration of hydrogen may be added to the fiber before irradiating with ultraviolet light. As a result of this hydrogen concentration, defects caused by the ultraviolet rays can be easily photochemically changed, which activates a reaction that causes a change in the refractive index.

Properties of FBG 1 that has been manufactured in such a manner are determined by an amount of change in the refractive index, a period Λ (FBG) of the phase gratings, and a length of FBG. The amount of change in the refractive index and a length of FBG affect the reflectance and bandwidth of FBG. The period of phase gratings determines a center wavelength of reflected light. This center wavelength λ_{B} is represented by the following equation:
λ_{B}=2×n₁×Λ(FBG)(n₁: refractive index of fiber core)

As the period Λ (FBG) of the phase gratings changes due to a distortion of the fiber 2 caused by a temperature change, it is better to utilize the system in a condition where the temperature is constant, in order to stabilize a reflection wavelength.

FIG. 2A is a detailed diagrams of the portion A of the external resonator of FIG. 1, and FIG. 2B is a detailed diagram of the portion B of FIG. 2A. FIGS. 2A and 2B show the relationship between phase gratings 33 in the FBG 1 and incident light where the phase gratings 33 are inclined by an angle β (hereinafter referred to as inclination angle β) relative to an orthogonal plane through the optical axis 36 of the optical fiber.

The critical angle θ_{c} where propagating light is totally reflected within the fiber core 27 is represented by the following equations:
θ_{c}=sin⁻¹(2Δ)^{1/2}
Δ=(n₁²−n₂²)/(2×n₁²)
where n₁ is the refractive index of the optical fiber core 27 and n₂ is the reflectance of the optical fiber cladding 34. As shown in FIG. 2B, light reflected by phase gratings 33 enters and reflects by an angle 2β that is twice as large as the inclination angle β. The Bragg condition is the same as the condition for total reflection. Therefore, when the inclination angle β satisfies the following condition, reflection light 22 from phase gratings 33 is totally reflected at the interface between the core and the cladding:
β≦θ_{c}/2

In this case, as reflected diffraction light 20 propagates at the angle of 2β, the reflected diffraction light 20 can return to the fiber core 27, which has the FBG 1, without directly interfering with the incident light.

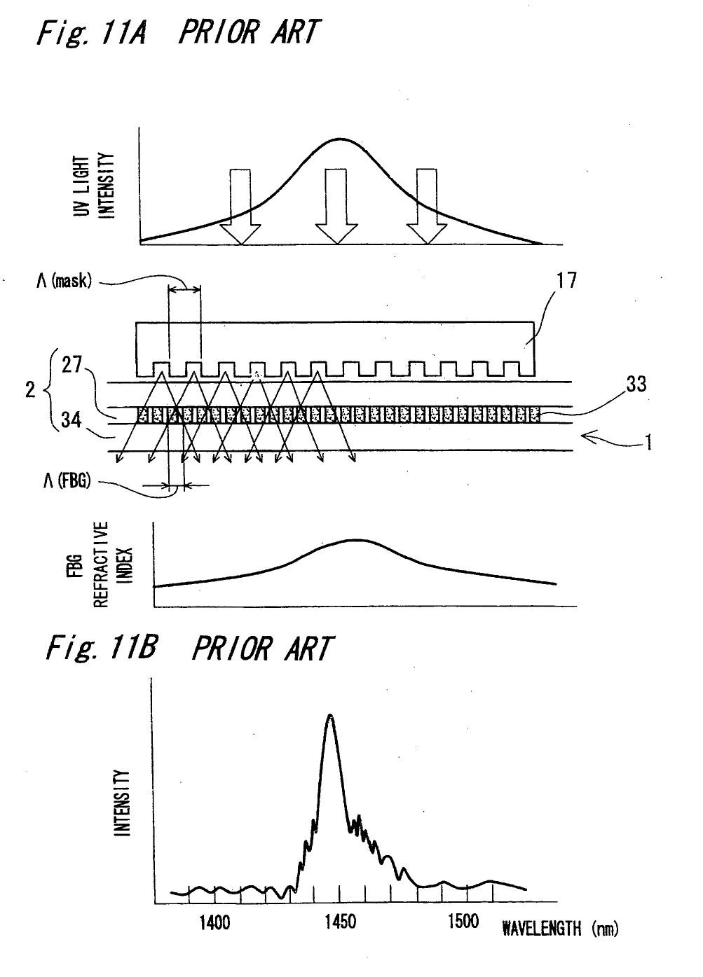

In the case of β=0° where the phase gratings 33 are formed perpendicular to the optical axis 36 of the fiber, the reflected diffraction light (the light 20 reflected from the FBG) directly collides and interferes with incident light (the light 19 outputted from the semiconductor laser). In addition, the Fabry-Perot resonance occurs, where light repeatedly goes and returns along the same light path between phase gratings 33. Accordingly, a number of peaks occur in a spectrum as side lobes as shown in FIG. 11B, resulting in a wide spectrum and serrate peaks and bottoms.

Accordingly, it is preferable for the angle β to satisfy 0<β≦θ_{c}2. By setting the inclination angle β of respective phase gratings 33 within the above range, reflected diffraction light (the light 20 reflected from the FBG 1) can return having less interference with an incident light.

Meanwhile, in the case of θ_{c}/2<β, the reflected diffraction light 20 easily leaks from the fiber core 27 to the fiber cladding 34. The light that has entered into the cladding 34 propagates within the cladding 34 in a multi-mode. The fiber core 27 is located in the center of the cladding 34, and the refractive index n₁ of the fiber core 27 is slightly greater than the refractive index n₂ of the cladding 34. Accordingly, the propagating light within the cladding 34 tends to be contained therein and periodically couple to and interfere with light within the fiber core 27. Therefore, it is preferable to reduce the propagating light within the cladding 34. For example, a material having a high refractive index (>n₂) may be attached around the cladding, or a metal thin film 35 such as Au, Co, Ni or Cr, which absorbs and attenuates the propagating light, may be deposited around the cladding. As a result, undesired light that propagates within the cladding 34 can be reduced.

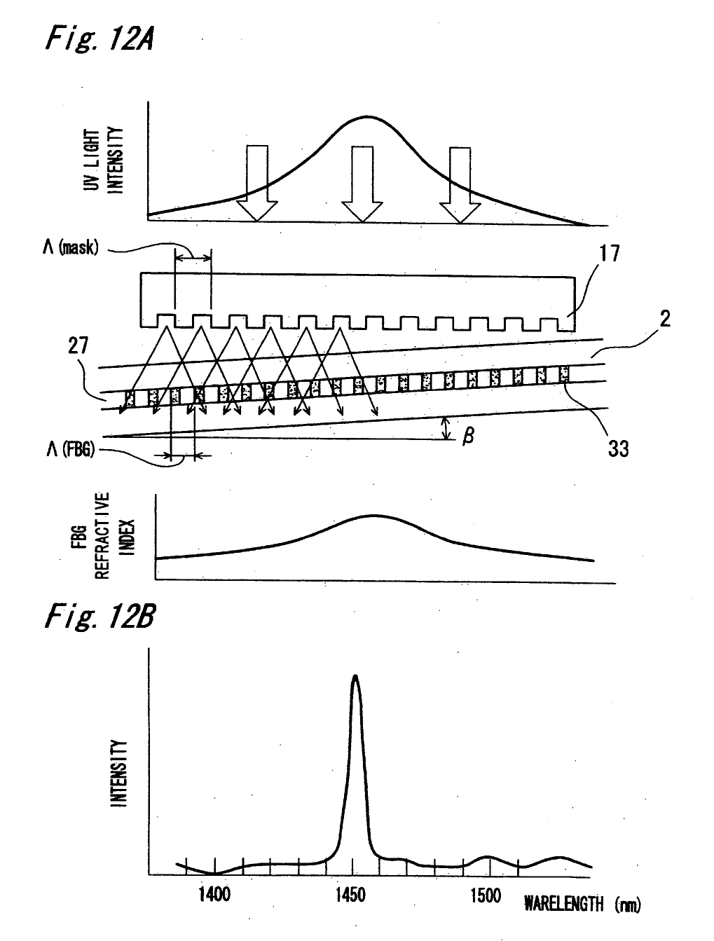

FIG. 12A shows a manufacturing method of FBG 1 where each phase gratings 33 has an inclination angle β as shown in FIG. 1. As shown in FIG. 12A, the optical fiber is set to incline relative to the diffracted UV light rays that are irradiated through the phase mask 17. An inclination angle β of the fiber can be attained when the optical fiber is inclined by β relative to the horizontal plane where the principal plane of the phase mask 17 is placed. Thus, an FBG 1 having phase gratings 33 inclined by β against an orthogonal plane of optical axis 36, see FIG. 2, of the fiber is provided. In this case, a spectrum of the FBG 1 becomes steep and has reduce serrated side lobes, as shown in FIG. 12B, when compare to the case of the prior art shown in FIG. 11B

With reference again to FIG. 1, the optical fiber 2 may be bonded to the inside of the ferrule 3 using an fixing member 8, which is preferably an adhesive material having a refractive index that is greater than the refractive index n₂ of the cladding 34. Alternatively, a thin film of Au, Cr, Ni, Co or the like may be formed around the external periphery of the fiber 2, where the FBG 1 is recorded, by means of a metallization process. In this case, the optical fiber may be bonded by means of metal soldering. Also, glass having a low melting point and having a high refractive index or light absorbing properties may be formed on the outside of the fiber in thin film form. The glass film may be heated to afix the fiber and ferrule. A metal solder or a low-melting-point glass are preferable as adhesive materials for an external resonator used in a semiconductor laser module 13 because unnecessary gases are not generated from such adhesive materials for fixing the fiber 2. If a metal solder is used, it is preferable to form, before securing by means of soldering, a metal thin film such as AuCr around the fiber 2 with a thickness of about 0.1 μm by means of vapor deposition. Though a conventional solder material may be used for securing, it is preferable to utilize AuSn or the like.

In the case where the refractive index of the fixing member 8 is greater than the refractive index n₂ of the cladding 34, or the fixing member 8 has light absorbing properties, light that has entered into the cladding 34 and propagating therein can be prevented from coupling to the propagating light within the fiber core 27.

The fiber 2 within the ferrule 3 may be heated to approximately 1500° C., and an additive, such as Ge, may be diffused into the fiber, in order to increase the refractive index of the fiber core, and thereby, the mode field diameter thereof (the diameter where the intensity of light that propagates within the single mode fiber becomes 1/e² of the peak) can be expanded two to three times. When an optical fiber is manufactured in such a manner, necessary position accuracy for coupling the optical fiber with the semiconductor laser 10 can be relaxed. This strengthens the coupling properties against a positional shift.

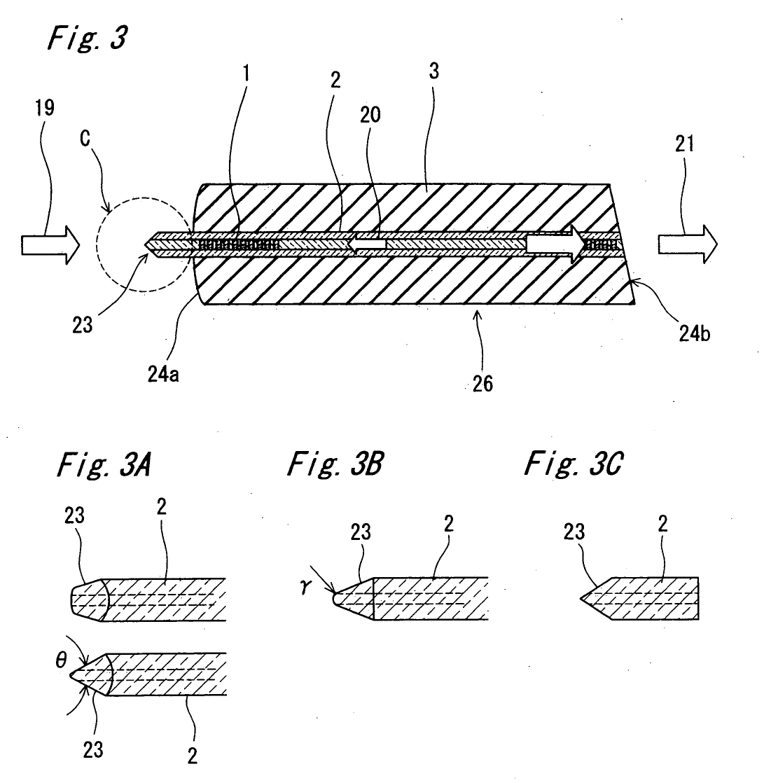

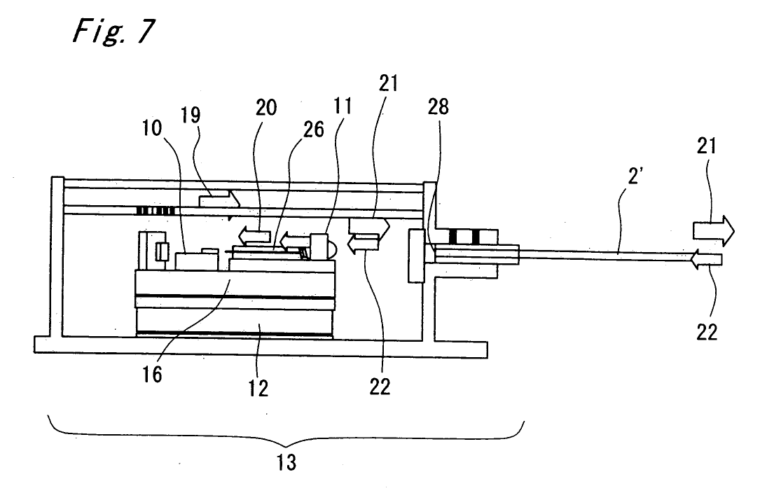

With reference to FIG. 3, it is preferable that an end surface 24a of the ferrule 3 has an approximate spherical form by PC polishing or the like and the other end surface 24b is inclined by a certain angle (3 to 8 degrees) to prevent reflection from the end face 24b. As shown in FIG. 7, this external resonator configuration can be attached onto the Pelletier element 12 within the semiconductor laser module 13 so as to be located between the coupling lens 11 and the semiconductor laser 10. Since the external resonator 26 is placed on the Pelletier element 12, the external resonator becomes less sensitive to an environmental temperature change.

With reference to FIG. 7, if a polarization-maintaining optical fiber is used for the optical fiber 2 within the ferrule 3, the semiconductor laser module 13, which may be used as a excitation light source for an optical fiber amplifier (not shown), can transmit light to an output fiber 2′ without changing a polarization direction. In particular, in order to increase an output of the excitation light source (not shown), it is preferable to couple polarized waves which cross at 90 degrees with each other. If a polarization-maintaining fiber is used as an output fiber 2′, it is preferable to use a polarization-maintaining fiber also for an external resonator 26 so that a polarization degree of light 19 emitted from the semiconductor laser is prevented from deterioration. In addition, if the optical fiber 2 is a polarization-maintaining fiber, the degree of polarization of the light 20 reflected from the FBG becomes stable, which contributes to the stabilization of the spectrum properties of the semiconductor laser.

When a fiber to which a rare earth has been added is utilized as the fiber 2 within the ferrule 3, the rare earth element that has been added to the fiber core 27 is excited by the excitation light 19 emitted from the semiconductor laser element 10 and rises to a higher energy level. Then, when the energy level drops to a stable level, light of a wide band is spontaneously emitted. A part of the spontaneously emitted wide-band light is reflected by FBG 1 as a reflected light component 20. This reflected light component is amplified by the excitation light emitted from the semiconductor laser element 10 while propagating between the FBG 1 and the semiconductor laser element 10, and is emitted as a stimulated emission from the end surface 24b of the ferrule 3. Thus, light having the reflection spectrum properties of the FBG 1 and having a different wavelength from that of the excitation light is emitted. In this case, by changing the temperature of the Pelletier element, the length of the fiber to which a rare earth has been added can be changed, and, thus, the period Λ (FBG) of the FBG 1 on the inside can be changed. As a result of this, the wavelength of light which is amplified and undergoes stimulated emission also changes. That is to say, it is possible to provide the configuration of a variable wavelength light source.

FIGS. 3 shows an embodiment of an external resonator of the present invention where an end face of an optical fiber 2 provided with FBG 1 in the ferrule 3 is formed to have a particular shape. The shape of the end face of the optical fiber 2 may be, as shown in FIGS. 3A to 3C, a wedge shape, a spherical tip shape, or a cone shape and the like. The form of the shaped end may be selected in accordance with the type of the semiconductor laser element 10.

For example, a semiconductor laser element 10 for a wavelength of 980 nm which is utilized as an excitation light source for an optical fiber amplifier generally outputs light 19 that has a elliptical near field pattern of which has an aspect ratio of approximately 1:5. In this case, it is preferable to use a fiber 2 with wedge-shaped end face as shown in FIG. 3. As the form of the convergence point of the wedge-shaped lens is elliptical, it can be approximately the same as that of the near field of the semiconductor laser element 10. By fitting the two forms, a coupling efficiency is highly improved. In the case where the near field pattern of the emitted light 19 is close to circle, it is preferable to use a fiber 2 having a spherical end as illustrated in FIG. 3B, or having a conical end as illustrated in FIG. 3C. In general, if the curvature radius “r” of an end of the fiber 2 is large, the convergence point of the lens becomes large. If the curvature radius “r” is small, the convergence point of the lens becomes small. Therefore, the form of the convergence point of the lens can be controlled to approximate the near field pattern of the semiconductor laser element 10, by selecting an appropriate curvature radius “r” of the tip of the fiber 2, so that a high coupling efficiency is obtained.

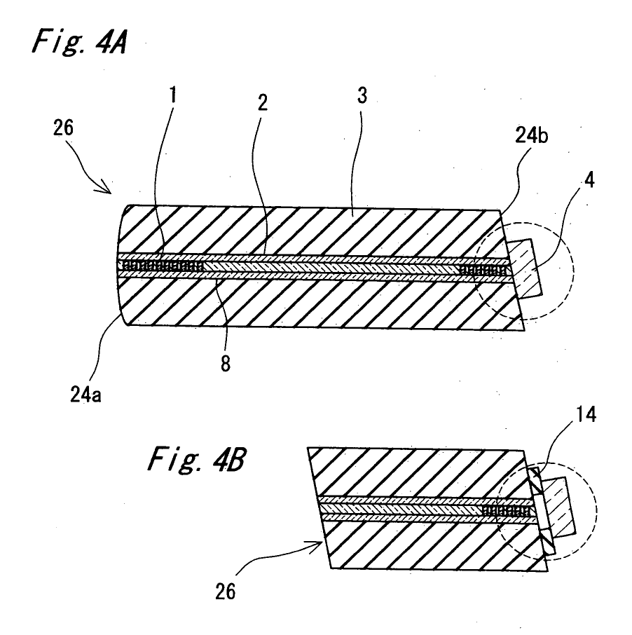

FIG. 4A shows an external resonator according to another embodiment of the present invention, where an optical element 4 is installed on an end surface 24b of the external resonator. An optical isolator, a filter, a Faraday rotator, a polarizer or the like can be used as the optical element 4. As for the method for installing the optical element 4 on the end surface 24b of the ferrule 3, the optical element may be fixed closely by means of an adhesive. Instead of this, as shown in FIG. 4B, the optical element may be secured while being slightly separated from the end surface 24b of the ferrule 3 by means of a spacer 14. By doing this, adhesive material can be eliminated from the light path. This is preferable from the viewpoint of reliance.

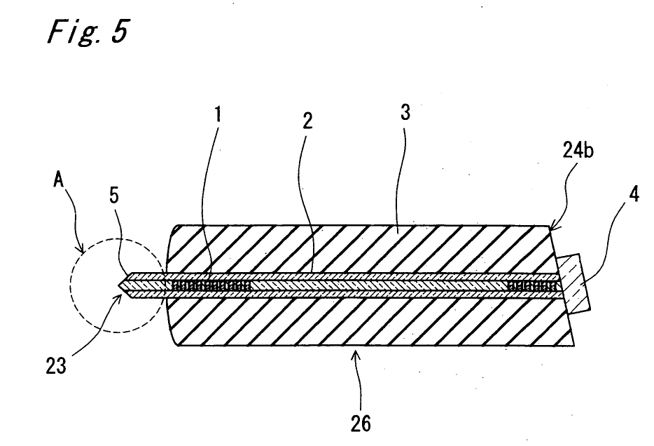

FIG. 5 shows another embodiment where an end 23 of the optical fiber 2 of FIG. 4 is provided with a lens 5. In general, external resonators 26 are connected to the semiconductor laser element 10 via a coupling lens 11. In the case where the lens 5 is formed by processing the end 23 of the fiber 2 on one side as shown in FIG. 5, the external resonator can be directly coupled with the semiconductor laser element 10.

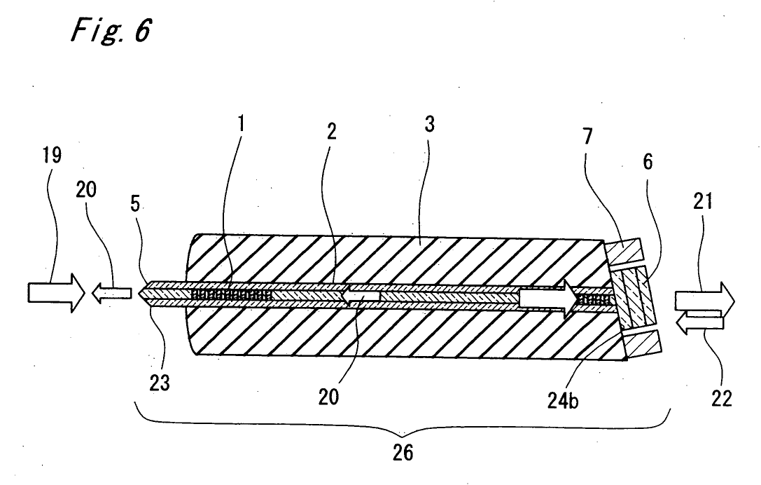

FIG. 6 shows another embodiment where an optical isolator 6 is formed on the end 24b of the ferrule 3 of an external resonator of FIG. 5. The optical isolator 6 may be composed of a Faraday rotator and a polarizer attached to both or one side of the Faraday rotator. The optical isolator 6 transmits light from the FBG 1 side, while blocking light 22 from an output fiber (not shown).

The surfaces of the respective elements of the optical isolator 6 are bonded to each other by means of a transparent adhesive, glass of a low melting point or the like. Alternatively, portions of the surfaces or the sides of the respective elements may be bonded by means of soldering. Also, the elements in the optical isolator 6 may be bonded by means of an ambient-temperature vacuum bonding without using a bonding material. A variety of methods can be used to form a laminated structure of the optical isolator 6. Attached on the end 24b is a magnet 7 for applying a saturated magnetic field to the Faraday rotator. Some types of optical isolators can do without such a magnet 7.

In addition, as shown in the embodiment of FIG. 4B, the optical isolator 6 may be attached to the end surface 24b of the ferrule 3 via a spacer 14 so that the optical isolator 6 is slightly separated from the ferrule 3.

FIG. 7 shows an example where the external resonator 26 with the optical isolator shown in FIG. 6 is mounted on a semiconductor laser module 13. The external resonator 26 is placed on top of a surface-mounting substrate 16 which is on the Pelletier element 12, and is coupled with an output fiber 2′ via a coupling lens 11.

Still with reference to FIG. 7, the light 19 emitted from the semiconductor laser element 10 enters into the lens 5 formed on the fiber end 23 of the external resonator 26 with an optical isolator. A portion (approximately 10%) of the light that has entered is returned by the FBG 1. The returned light 20 reflected from the FBG, which has a predetermined wavelength, resonates between the FBG 1 and the semiconductor laser element 10 and, thus, stimulates emission with the reflection spectrum properties of the FBG 1. The light 21 that has transmitted through the FBG 1 further transmits through the optical isolator 6, see FIG. 6, that is attached to one end of the external resonator 9, and enters into an end 28 of output fiber 2′ through a coupling lens 11. Any unnecessary return light 22 from the output fiber 2′ is blocked by the optical isolator 6, and therefore, does not return to the semiconductor laser element 10. The external resonator 26 is mounted on the Pelletier element 12, and thereby, the temperature thereof is adjusted, providing stable operation of the external resonator, where there is almost no fluctuation in the wavelength and in the output.

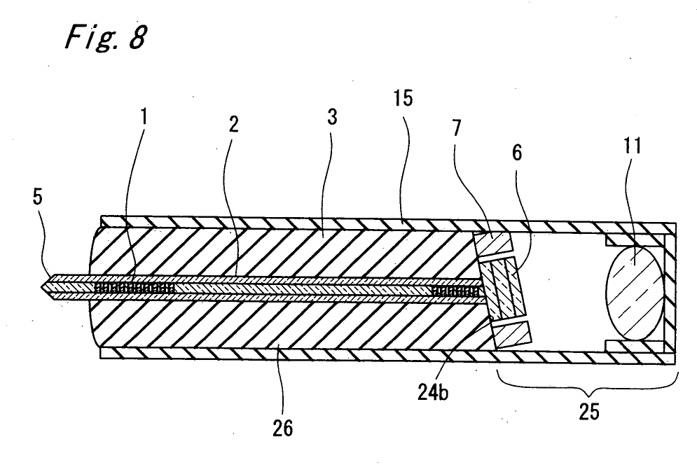

FIG. 8 shows an external resonator according to another embodiment of the present invention. In this embodiment, the external resonator 26 in the embodiment of FIG. 6 is mounted within a sleeve 15, and a coupling lens 11 which is spherical or aspherical is attached to an end surface of the sleeve 15. An external resonator of this embodiment has more integrated functions and can be directly mounted on a semiconductor laser module. The coupling lens 11 may be attached on an end face 24b of ferrule 3 together with an optical isolator 6, instead of being attached to sleeve 15.

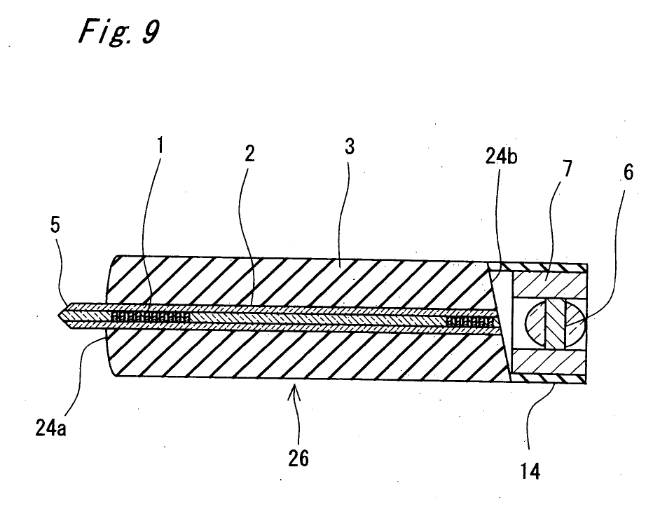

FIG. 9 shows a configuration where the optical element 4 that forms the optical isolator 6 is in a spherical lens form and is attached to the end surface 24b of the ferrule 3 of the external resonator 26. This configuration provides more integration of functions than in the configuration of FIG. 8. In order to provide an optical isolator 6 with a lens function, various kinds of ways are available. For example, a diffraction grating may be attached on one surface of an optical isolator. The diffraction grating may be formed by making a relief on the surface of an optical isolator. If a diffraction grating is integrated to an optical isolator, the optical isolator 6 can function as lens while maintaining its planar shape, which is preferable for a higher integration of an optical module.

In the case where two optical isolators which are the same as the above described optical isolator 6 are utilized in continuous manner, an increase in the level of isolation becomes possible, and at the same time, it becomes unnecessary to separately prepare a coupling lens 11 that is used for coupling to the output fiber 2. It is preferable for the refractive index of the polarizer on the two sides of the utilized Faraday rotator to be not less than 1.7, and for the outer diameter of the spherical lens formed on the optical isolator 6 to be approximately 1 mm to 2 mm. As a result of this, the diameter of the aberration circle in the vicinity of the convergence point of the spherical lens becomes small, making coupling to the optical fiber 2 easy, and increasing the quality of the coupling.

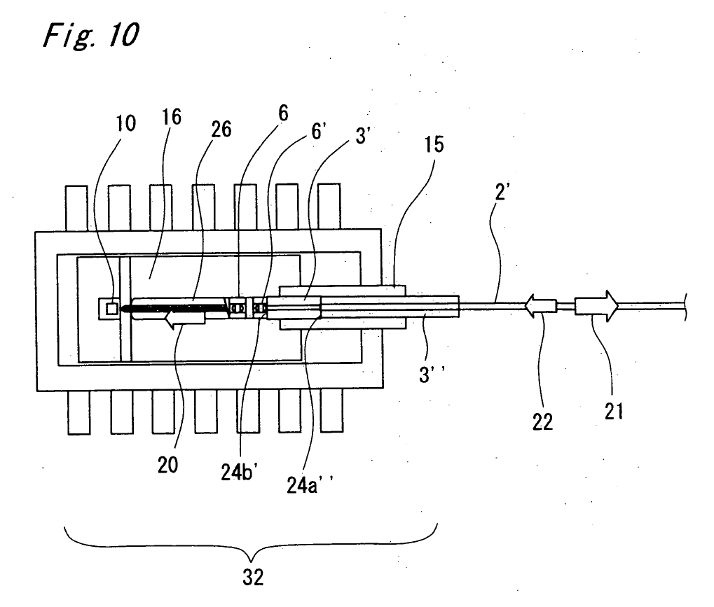

FIG. 10 shows a configuration where the semiconductor laser element 10 is mounted on a surface-mounting substrate 16 made of material such as Si or ceramic, and the external resonator 26 with an optical isolator, as shown in FIG. 9, is mounted so as to be coupled to the output fiber 2′. Two optical isolators 6, 6′ in spherical form are installed. One of the optical isolators 6′ is attached to the end surface 24b′ of a ferrule 3′ that is used for adjusting a position for achieving optimal coupling. The ferrule 3′ is secured to the inside of the sleeve 15, and connected to the end surface 24a′ of the ferrule 3″ of the output fiber 2′ that is also secured in the sleeve 15. Here, the connection of ferrule 3′ to the end surface 24a″ on one side of the ferrule 3″ may be achieved by processing either ferrule into a connector form.

### EXAMPLES

An external resonator according to the present invention was actually manufactured and mounted on a semiconductor laser module as shown in FIG. 7. An FBG 1 having a center wavelength λB of the reflected light of 1450 nm was manufactured by using a fiber 2 where mode effective refractive index n₁=1.525, n₂=1.51, Δ=0.00979, and θ_{c}=8°, and a phase mask 17 where Λ (MASK)=951 (nm). Here, Δ and θ_{c} are calculated in the following equations:
Δ=(1.525²−1.51²)/(2×1.525²)=0.00979
θ_{c}=sin⁻¹(2×0.00979)½=8.04°

UV light of an intensity of approximately 500 mW was utilized to irradiate the phase mask 17. In addition, the intensity distribution of the UV light was in the Gaussian state, and the amount of change in the refractive index of the FBG 1 had a distribution in the Gaussian state in the direction of the center axis of the FBG 1. Furthermore, at the time of recording, the fiber was inclined by an inclination angle β from the horizon. Here, β was set to 3° (0°<β≦θ_{c}).

In this manner, the respective phase gratings 33 that formed the FBG were provided with the refractive index distribution in the Gaussian state, and in addition, the phase gratings 33 having the inclination angle β=3° relative to the orthogonal plane of optical axis 36 of the fiber to be formed. As a result of this, unnecessary reflection caused by the Fabry-Perot resonance between the two ends of the FBG 1 was suppressed, the side lobes, which are a number of peaks in the spectrum of the reflected light, were suppressed, and the reflection spectrum properties of a narrow band could be obtained.

The fiber 2 having a cladding diameter of 125 μm and a core diameter of 8 μm was utilized with its protective coating peeled. In addition, before recording the phase gratings on the fiber, the fiber was subjected to pressure in a high pressure hydrogen environment (25 degrees C., 200 atm, for ten days), so that the inside of the fiber 2 was filled in with hydrogen. Twenty hours after the release of the pressure application, the fiber 2 was irradiated with UV light. The UV light was provided with an intensity distribution in the Gaussian state via the phase mask 17 where Λ (MASK)=951 (nm), and irradiated the fiber for forty minutes. In this manner, an FBG 1 where Λ (FBG)=475 nm was manufactured. The reflection spectrum properties thereof had a center wavelength λB of 1450 nm, as shown in FIG. 12. Steep reflection properties were attained where the side lobes on the two sides of the center wavelength were suppressed, as shown in FIG. 12.
λB=2 ×1.525×95½=1450 (nm)

The fiber was cut out so that its length became 10 mm, and a metallization process was carried out on the external periphery of the cladding 34 using NiAu, so as to provide a metal thin film 35. Then, the fiber was inserted into a ferrule 3 having an outer diameter of 2.5 mm and a length of 5 mm, which was secured by using an Au/Sn solder material as the FBG fixing member 8.

One side of the fiber 2 was made to protrude by 1 mm from the end surface 24 on one side of the ferrule 3, and this end of the fiber was processed. The end was processed into a wedge shape, as shown in FIG. 3A, because the aspect ratio of the near field of the utilized semiconductor laser element 10 was 1:2. The angle θ of the wedge was approximately 90 degrees and the tip of wedge was slightly spherical. As a result of this, the coupling efficiency between the fiber and the semiconductor laser element 10 could be adjusted to be in a range from approximately 70% to 80%. The coupling efficiency in the case where the end of the fiber 2 was not processed and a conventional coupling lens 11 (the aberration at the convergence point was circular) was used for the coupling, was approximately 40%, which is almost half of that described above. Accordingly, in the case where an end of the fiber 2 was processed so as to be directly coupled to the semiconductor laser element 10, the coupling efficiency doubled, in comparison with the coupling by means of a conventional lens 11 for coupling.

After that, the other end of the ferrule 3 was polished and processed to have a surface inclined by 8°. In addition, the optical isolator 6 had a Faraday rotator made of a Bi-containing garnet material having a thickness of approximately 250 μm. The optical isolator 6 had a laminated structure, where the Faraday rotator was sandwiched by absorption type polarizers having a thickness of 0.3 mm from the two sides, and was cut out so as to have a diameter of 1 mm. This optical isolator, an end of which a spherical lens was attached to, was attached to the end of one side of the ferrule 3, into which the FBG 1 was incorporated via a transparent adhesive. The reflection wavelength of the FBG 1 was 1450 nm, and the reflectance was approximately 13%. The external resonator 26 with the optical isolator which had been manufactured under the above described conditions was mounted on a semiconductor laser module 13 into which a Pelletier element was incorporated. The semiconductor laser element 10 could stably carry out an oscillation operation, because the returning light in the band of 1450±20 nm, where 1450 nm is its oscillation wavelength, was removed.

Here, the optical element 4 in the present example is not limited to the optical isolator 6, but rather, may be an optical filter element or an optical isolator+optical filter element. In the case where the optical element is an optical filter, for example, the spectrum properties of the light emitted from the FBG 1 can be made steeper by means waveform shaping. The optical filter may be a band pass filter which transmits light having the same wavelength as the light emitted from the semiconductor laser element 10 to the FBG 1, while removing unnecessary light 22 having a wavelength different from the above described wavelength. In the case where the wavelength of the semiconductor laser element 10, which is a light source for excitation, is 1480 nm in a fiber amplifier (not shown) for a 1550 nm band, spontaneously emitted light components in a wide band of wavelengths from 1530 nm to 1580 nm return to the semiconductor laser element 10 from the fiber, to which Er has been added, within the amplifier, and this light has a wavelength which is close to that of the oscillation of the semiconductor laser element 10, making this oscillation unstable. In order to prevent this, a band pass filter for blocking light of this band of wavelengths from 1530 nm to 1580 is attached to the end surface on one side, so as to remove the unnecessary light 22, and therefore, the semiconductor laser element 10 oscillates stably, increasing the stability in the output of the system. The optical element 4 could be used for removing the undesired light 22. This enables a stable oscillation of a semiconductor laser element 10, and stabilizes an output and spectrum properties.

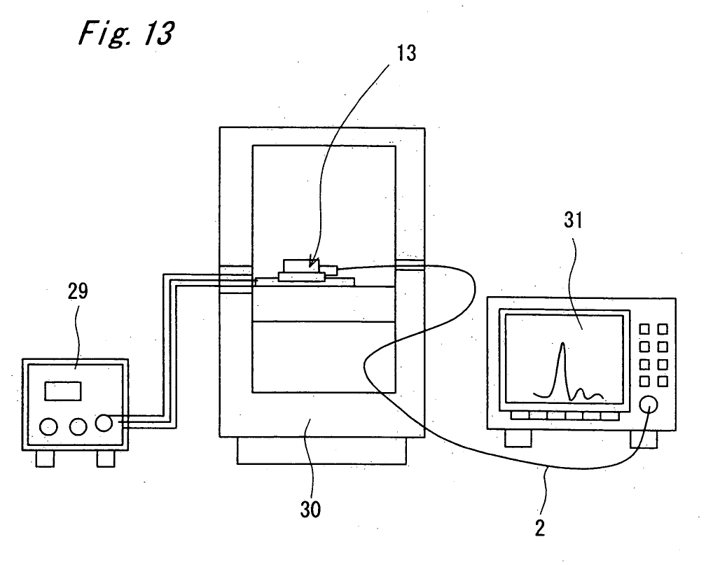

FIG. 13 shows a system for measuring a oscillation spectrum properties of manufactured semiconductor laser modules 13. Semiconductor laser module 13 is mounted on a substrate, installed within a constant temperature booth 30, and connected to a laser driver 29 for an APC control. Light is emitted by drawing an electric current from the laser driver 29, and emission light from an output fiber 2 is inputted into a light spectrum analyzer 31. The temperature of a constant temperature bath 30 is controlled between −20° C. and +70° C., and thereby, the temperature properties of the oscillation spectrum can be measured.

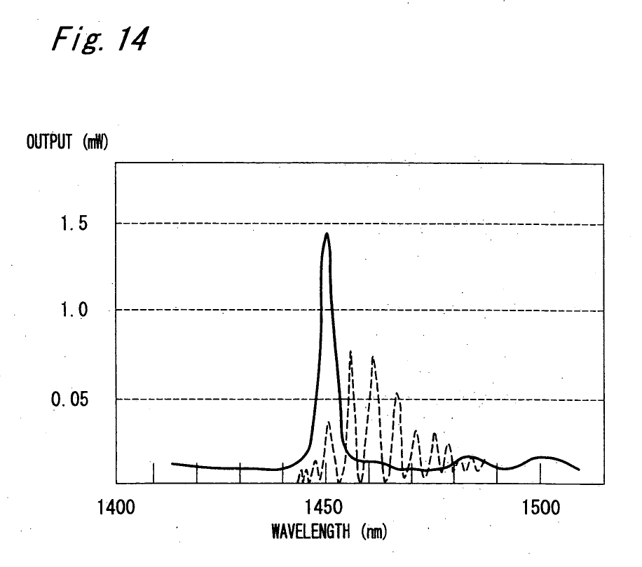

The oscillation spectrum properties of a semiconductor laser module provided with the external modulator with an optical isolator is shown by the solid line in FIG. 14. The oscillation spectrum properties of a module without an external modulator are shown by the dotted line in FIG. 14. The oscillation which spreads in the case without external resonator is attracted to the FBG 1, in a manner where the oscillation of the FBG 1 becomes the primary oscillation. The center wavelength thereof is almost the same as the center wavelength, 1450 nm, of the reflection of the FBG 1 of the utilized external resonator 26. As a result of this, narrowing of the band of the spectrum and an increase in the output has been achieved.

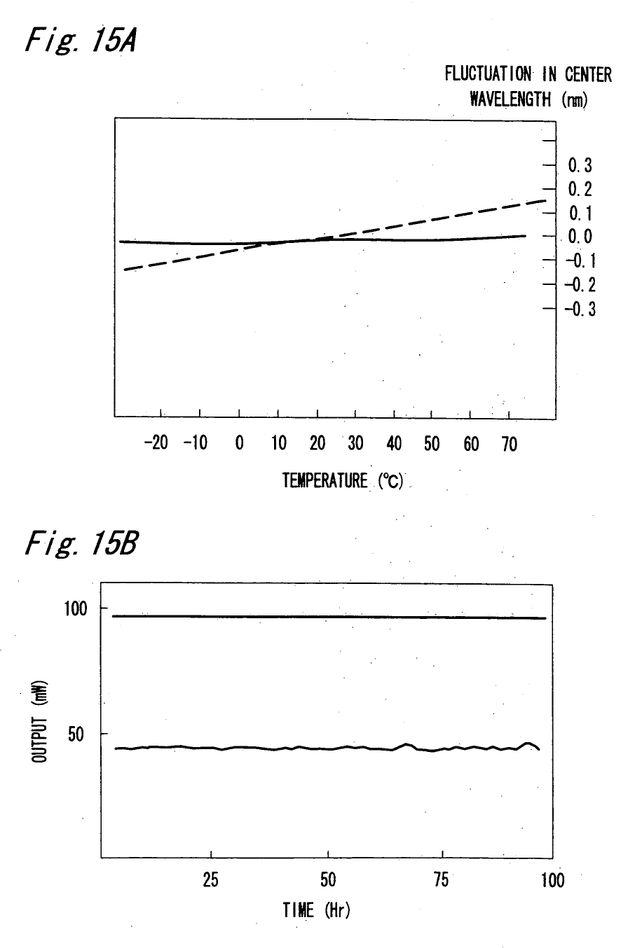

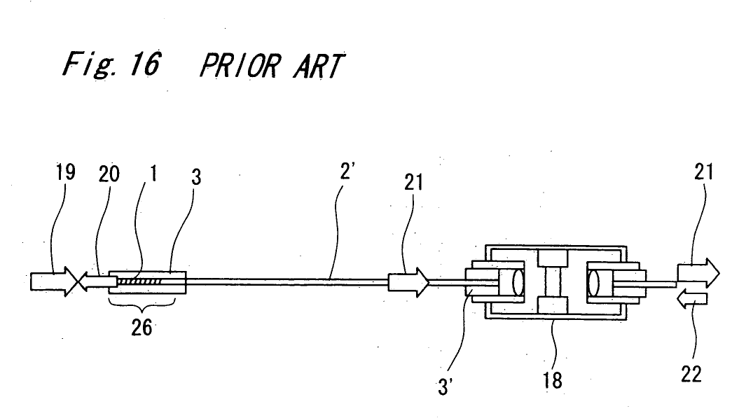

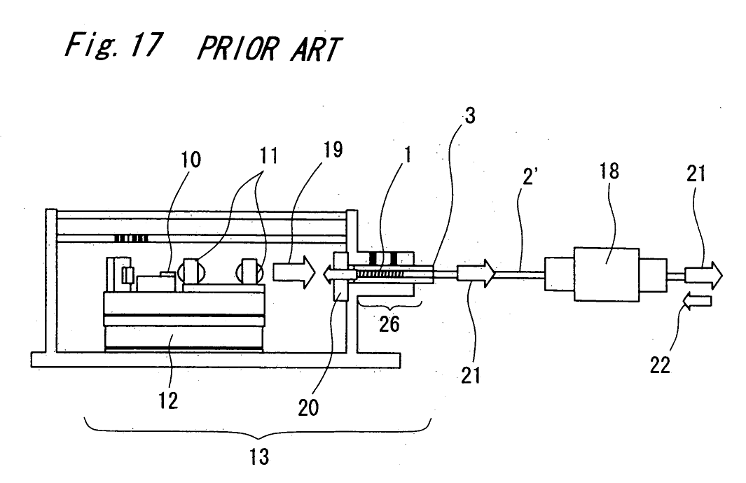

FIG. 15 shows the stability of the central wavelength against the temperature in the case where the external resonator 26 with an optical isolator according to the present invention is utilized by being directly connected to the semiconductor laser element 10 having an oscillation wavelength of 1450 nm. Unlike a case where a conventional external resonator is utilized, the external resonator exhibits extremely stable wavelength properties against changes in the external temperature, where the wavelength of the output light barely shifts, even when the temperature changes. That is to say, high wavelength stability against a temperature change and high output properties are exhibited.

Though the fiber 2 held within the ferrule 3 was a conventional single mode fiber in these examples, an optical fiber is not limited to the single mode fiber. For example, a core expanded fiber may be used. A core mode fiber can be formed by heating a single mode fiber to approximately 1500° C. and diffusing an additive, which increases the refractive index of the fiber core 27. In the case where the FBG 1 is formed of a core expanded filter, less precision is necessary in aligning an external resonator in a laser semiconductor module.

In the case where a polarization-maintaining fiber is utilized, the polarization surface of the FBG-reflected light 2 from the external resonator 26 becomes exactly the same polarization surface as that of the light 19 emitted from the semiconductor laser element 10, and therefore, a stable oscillation operation can be gained. Accordingly, stable spectrum properties can be implemented, even when the external temperature changes. In particular, in the case of semiconductor laser module 32, as shown in FIG. 9, where the temperature is not controlled by the Pelletier element 12, usage of a polarization-maintaining fiber is effective, in order to maintain the stability of the wavelength and output properties.

In the case where a rare earth containing fiber, to which a rare earth element, such as Er or Tm, has been added, is utilized, the output having a wavelength particular to the added rare earth element can be obtained from the system where the semiconductor laser element 10 is used as the excitation light source. Er is utilized as the rare earth element, and excitation is carried out by using excitation light from the semiconductor laser element 10 of which wavelength is 980 nm. In this case, light in a band of 1550 nm, of which spectrum properties are particular to the FBG 1, is outputted within the FBG 1 to which Er has been added, providing a high output light source. The wavelength and the spectrum properties thereof depend on the properties of the FBG 1. The temperature of the FBG 1 can be changed so that the grating period Λ can be changed due to the thermal expansion or contraction of the FBG 1. As a result of this, the wavelength of the peak of the output light changes, and therefore, the system can be utilized as a wavelength variable light source. It is possible to apply such a light source to various semiconductor laser modules.

The present invention is not limited to a semiconductor laser module 13 as described above. For example, it is possible to mount an external resonator of the present invention within an in-line type optical module 18, or it is possible to expand the application so that an external resonator of the present invention can be used as a light receiving part.

1. An external resonator comprising:
an optical fiber having a core and a cladding, said core being provided with a fiber Bragg grating that reflects light of a specific wavelength; and
a ferrule that holds said optical fiber,
wherein at least part of phase gratings in said fiber Bragg grating are inclined against an orthogonal plane of an optical axis of said optical fiber.

2. The external resonator according to claim 1, wherein an angle β formed between said inclined phase gratings and said orthogonal plane satisfies the following equations:
0°<β≦θ_{c}/2;
θ_{c}=sin⁻¹(2Δ)^{1/2}; and
Δ=(n₁²−n₂²)/(2×n₁²);
where n₁ is a refractive index of the core of said fiber, n₂ is a refractive index of the cladding of said fiber and θ_{c} is a critical angle where propagating light is totally reflected:

3. The external resonator according to claim 1, wherein a metal thin film is provided around an external periphery of the cladding of said fiber.

4. The external resonator according to claim 1, wherein said optical fiber has a shaped end face.

5. The external resonator according to claim 1, wherein the shape of said end face is cuneiform, spherical or conical

6. The external resonator according to claim 1, wherein an optical element is attached to at least one end face of said ferrule.

7. The external resonator according to claim 6, wherein said optical element has an optical isolator function and/or an optical filtering function.

8. The external resonator according to claim 6, wherein a lens for coupling is coupled to an end face of said ferrule.

9. The external resonator according to claim 6, wherein said optical element is in a form that has a lens function.

10. The external resonator according to claim 6, wherein a lens or grating is formed on an end face of said optical element.

11. An optical fiber comprising:
a core being formed with a fiber Bragg grating that reflects light of a specific wavelength; and
a cladding covering said core;
wherein at least part of phase gratings in said fiber Bragg grating are inclined against an orthogonal plane of an optical axis of said optical fiber.

12. The optical fiber according to claim 11, wherein an angle β formed between said phase gratings and said orthogonal plane satisfies the following equations:
0°<β≦θ_{c}/2;
θ_{c}=sin⁻¹(2Δ)^{1/2}; and
Δ=(n₁²−n₂²)/(2×n₁²);
where n₁ is a refractive index of the core of said fiber, n₂ is a refractive index of the cladding of said fiber and θ_{c} is a critical angle where propagating light is totally reflected.

13. The optical fiber according to claim 11, wherein a metal thin film is provided around an external periphery of said cladding.

14. The optical fiber according to claim 11, wherein said optical fiber has a shaped end face.

15. The optical fiber according to claim 11, wherein the shape of said end face is cuneiform, spherical or conical

16. A method for manufacturing an optical fiber having a fiber Bragg grating that reflects light of a specific wavelength, comprising the steps of:
arranging an optical fiber and a mask for forming said fiber Bragg gratings so that said optical fiber is inclined against a principal plane of said mask, and
irradiating an electromagnetic wave to said optical fiber through said mask for forming said fiber Bragg grating.

17. A semiconductor laser module comprising:
a semiconductor laser;
an output fiber for transmitting an output light from said semiconductor laser; and
an external resonator according to claim 1, said external resonator being disposed between said semiconductor laser and an end face of said output fiber.

18. The semiconductor laser module according to claim 17, wherein an end face of said optical fiber in said external resonator is shaped to be cuneiform, spherical or conical.

19. The semiconductor laser module according to claim 17, wherein an optical element having an optical isolator function and/or an optical filtering function is attached to at least one end face of said ferrule in said external resonator.

20. The semiconductor laser module according to claim 19, wherein said optical element is in a form that has a lens function.

21. An external resonator comprising:
a ferrule dimensioned to receive an optical fiber: and
an optical fiber positioned with said ferrule and having a core and a cladding, and said core includes fiber Bragg gratings that are inclined with respect to an orthogonal plane through an optical axis of said optical fiber.

22. The external resonator of claim 21, wherein an angle β is formed between said inclined phase gratings and said orthogonal plane that satisfies the following:
0°<β≦θ_{c}/2;
θ_{c}=sin⁻¹(2Δ)^{1/2}; and
Δ=(n₁²−n₂²)/(2×n₁²);
where n₁ is a refractive index of the core of said fiber, n₂ is a refractive index of the cladding of said fiber and θ_{c} is a critical angle where a propagating light is totally reflected.

23. An optical fiber comprising:
a core that defines an optical axis and includes a fiber Bragg grating that reflects light of a specific wavelength with at least portion of said fiber Bragg grating being phase gratings that are inclined relative to an orthogonal plane through said optical axis; and
a cladding covering said core.

24. The fiber of claim 23, wherein an angle β is formed between said inclined phase gratings and said orthogonal plane that satisfies the following:
0°<β≦θ_{c}/2;
θ_{c}=sin⁻¹(2Δ)^{1/2}; and
Δ=(n₁²−n₂²)/(2×n₁²);
where n₁ is a refractive index of the core of said fiber, n₂ is a refractive index of the cladding of said fiber and θ_{c} is a critical angle where a propagating light is totally reflected.

25. A semiconductor laser module comprising:
a semiconductor laser;
an optical fiber for transmitting an output light from said semiconductor laser; and
an external resonator disposed between said semiconductor laser and an end face of said optical fiber where said external resonator is comprises:
a ferrule dimensioned to receive an optical fiber: and
an optical fiber positioned with said ferrule and having a core and a cladding, and said core includes fiber Bragg gratings that are inclined with respect to an orthogonal plane through an optical axis of said optical fiber.

26. The semiconductor laser module of claim 25, wherein an end face of said optical fiber in said external resonator is shaped selected from cuneiform, spherical and conical.

27. The semiconductor laser module of claim 25, wherein an optical element having an optical element is attached an end face of said ferrule in said external resonator.
